(19) United States
(12) Patent Application Publication
(10) Pub. No.: US 2013/0118240 A1
(43) Pub. Date: May 16, 2013

(54) MOISTURE CONTENT ANALYSIS SYSTEM

(71) Applicant: Dow Agrosciences LLC, Indianapolis, IN (US)

(72) Inventor: Randall James Clark, Mayville, WI (US)

(73) Assignee: DOW AGROSCIENCES LLC, Indianapolis, IN (US)

(21) Appl. No.: 13/664,755

(22) Filed: Oct. 31, 2012

Related U.S. Application Data
(60) Provisional application No. 61/558,626, filed on Nov. 11, 2011.

(51) Int. Cl. G01N 35/00

(52) U.S. Cl. 73/73

(57) ABSTRACT

A method of collecting data to determine a moisture content of a sample of plant material is disclosed. The method comprising the steps of providing an analysis chamber with a window and a scanner located outside of the analysis chamber; moving the sample of plant material through the analysis chamber; compressing the sample of plant material against the window as the sample of plant material is being moved through the analysis chamber; and analyzing the sample of plant material with the scanner through the window to produce data.

### RELATED APPLICATIONS

This application claims the benefit of U.S. Provisional Application Ser. No. 61/558,626, filed Nov. 11, 2011, titled MOISTURE CONTENT ANALYSIS SYSTEM, docket DAS-P0202-US, the disclosure of which is expressly incorporated by reference herein.

### FIELD OF THE DISCLOSURE

The present disclosure relates to methods and apparatus for analysis of the moisture content of a sample. In particular, the present disclosure relates to the analysis of the moisture content of silage using near-infrared spectroscopy.

### BACKGROUND OF THE DISCLOSURE

Silage is prepared in accordance with the moisture of the plants. A range of plant moisture is ideal for silage preparation, and so plant material is sampled and treated according to its moisture content. Current methods of silage moisture content analysis require a sub sample of the silage to be weighed wet, and then weighed again once all of the moisture has been removed. Handling a number of silage samples in this way is difficult, expensive, and requires the use of driers, which may be away from the field. The current method creates a bottleneck for silage harvesting.

### SUMMARY

In an exemplary embodiment of the present disclosure, a method of collecting data to determine a moisture content of a sample of plant material is provided. The method comprising the steps of providing an analysis chamber with a window and a scanner located outside of the analysis chamber; moving the sample of plant material through the analysis chamber; compressing the sample of plant material against the window as the sample of plant material is being moved through the analysis chamber; and analyzing the sample of plant material with the scanner through the window to produce data. In one example thereof, the scanner is a near-infrared scanner. In a variation thereof, the window is substantially optically transparent to near-infrared wavelengths. In another example thereof, the step of moving the sample of plant material through the analysis chamber includes the steps of contacting the sample of plant material with an analysis conveyer; and actuating the analysis conveyer to translate the sample of plant material through the analysis chamber. In a variation thereof, the step of compressing the sample of plant material against the window as the sample of plant material is being moved through the analysis chamber includes the step of reducing a separation between the analysis conveyer and a wall of the analysis chamber, the wall including the window. In a further example thereof, the sample of plant material is maize silage. In a variation thereof, the step of compressing the sample of plant material against the window as the sample of plant material is being moved through the analysis chamber removes substantially all of the air pockets between the maize silage and the window. In still another example thereof, the method further comprises the step of determining a moisture content of the sample.

In another exemplary embodiment of the present disclosure, a method of collecting data to determine moisture content of a plurality of samples of plant material is provided. The method comprising the steps of receiving a first sample of plant material in a hopper; transporting the first sample of plant material from the hopper to an analysis chamber with a window and a scanner located outside of the analysis chamber; and analyzing the first sample of plant material with the scanner through the window while a second sample of plant material is being one of received in the hopper and transported from the hopper to the analysis chamber. In one example thereof, the method further comprises the steps of moving the first sample of plant material through the analysis chamber; and compressing the first sample of plant material against the window as the first sample of plant material is being moved through the analysis chamber. In another example thereof, the first sample of plant material is received in the hopper from a weigh chamber of a mobile silage sampler machine.

In still another exemplary embodiment of the present disclosure, an apparatus for collecting data to determine a moisture content of a sample of plant material is provided. The apparatus comprising an analysis chamber bounded by a plurality of walls, the analysis chamber including an entrance and an exit, a first wall having an opening therein; a window covering the opening in the first wall; a scanner positioned to project energy through the window into the analysis chamber onto the sample of plant material and to receive reflected energy from the sample of plant material through the window; and an analysis conveyer to move the sample of plant material through the analysis chamber, the sample of plant material being compressed against the window as the sample of plant material is being moved through the analysis chamber. In one example thereof, a separation between the first wall and the analysis conveyer is reduced to compress the sample of plant material against the window. In a variation thereof, a space between the first wall and the analysis conveyer is wedge shaped. In another example, the scanner is a near-infrared scanner and the window is substantially optically transparent to near-infrared wavelengths. In yet another example thereof, the sample of plant material is maize silage. In still another example thereof, the compression removes substantially all of the air pockets between the sample of plant material and the window. In yet still another example thereof, the apparatus further comprises a hopper to store the sample of plant material prior to the sample of plant material being moved to the analysis chamber. In a variation thereof, the sample of plant material is moved from the hopper to the analysis chamber on a conveyer. In a further example thereof, the apparatus further comprises a switch positioned to monitor the analysis chamber, wherein the switch is activated when the sample of plant material is in the analysis chamber and is deactivated when the sample of plant material is absent from the analysis chamber. In a variation thereof, the scanner is activated when the switch is activated and is deactivated when the switch is deactivated.

The above and other features of the present disclosure, which alone or in any combination may comprise patentable subject matter, will become apparent from the following description and the attached drawings.

### BRIEF DESCRIPTION OF THE DRAWINGS

The detailed description of the drawings particularly refers to the accompanying figures in which:

FIG. 1 is a perspective view of an exemplary silage analysis apparatus according to an embodiment of the present disclosure.

FIG. 2 is a side cross-sectional view of the silage analysis apparatus of FIG. 1, taken along line 2-2.

FIG. 3 is a side perspective cross-sectional view of the silage analysis apparatus of FIG. 1, taken along line 2-2.

FIG. 4 is a side perspective view of the silage analysis apparatus of FIG. 1, with the right wall removed.

FIG. 5 is a rear perspective view of the silage analysis apparatus of FIG.

FIG. 6 is an illustrative view of an exemplary silage sampler including the silage analysis apparatus of FIG. 1.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to and described using the example of silage analysis, it should be understood that the features disclosed herein may have application to the moisture content analysis of other plant materials.

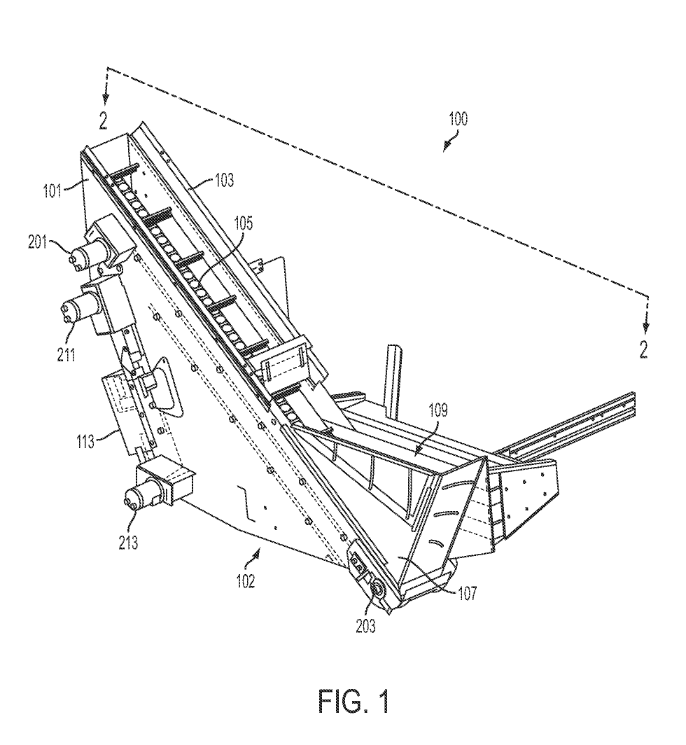

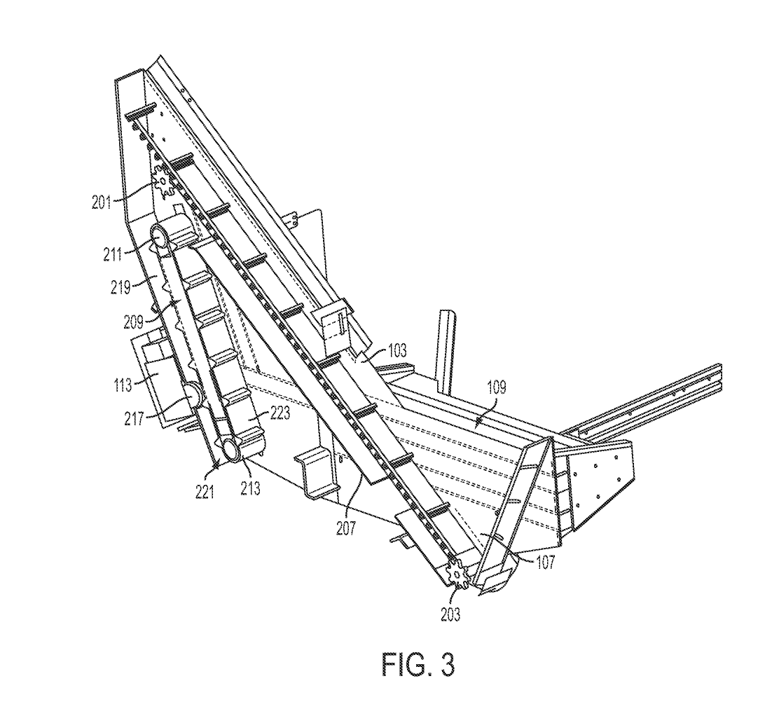

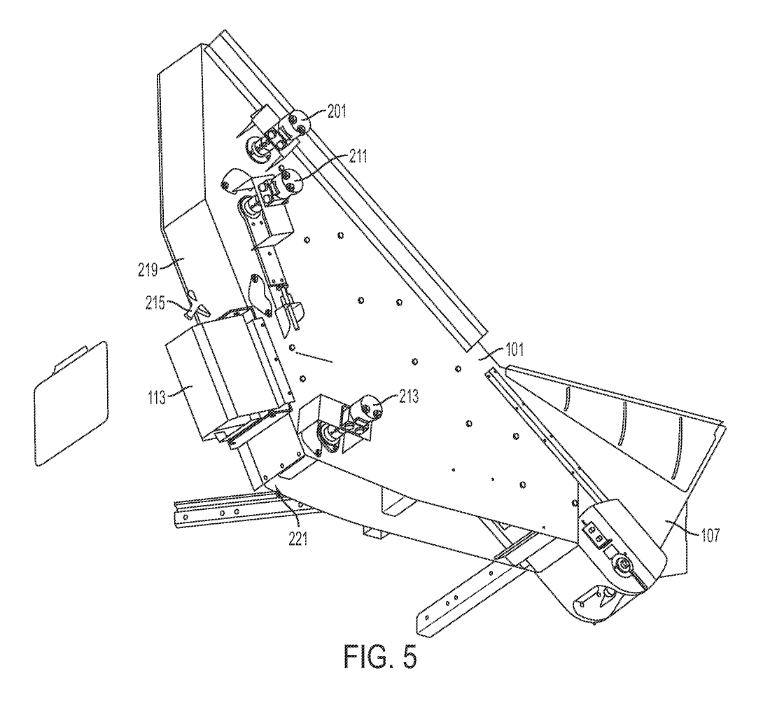

Referring to FIGS. 1-5, an exemplary silage analysis system 100 is shown. Silage analysis system 100 may be used to determine one or more characteristics of a plant material. An exemplary characteristic is moisture content and an exemplary plant material is maize silage.

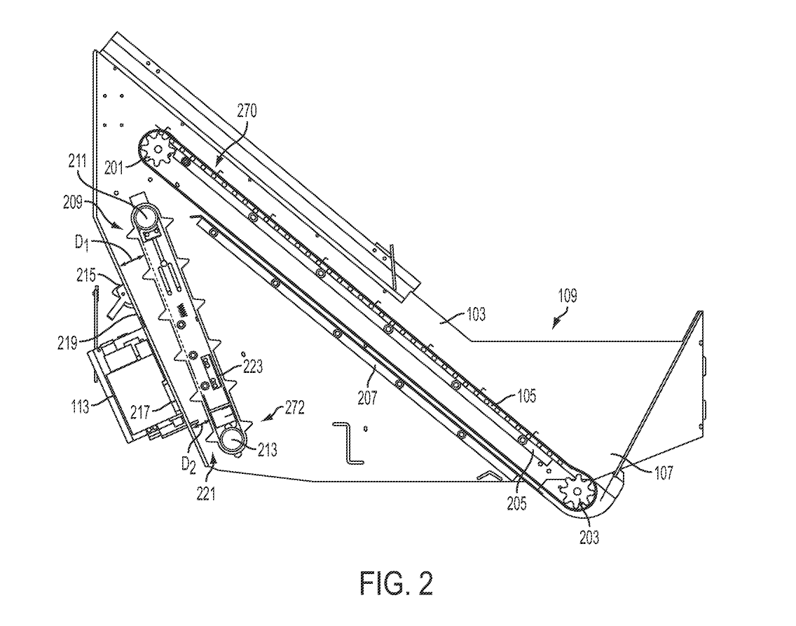

The silage analysis system 100 includes a frame 102 including a left wall 101 and a right wall 103. The silage analysis system 100 further includes a hopper 107 to hold silage, a conveyer 105 to move the silage from the hopper 107 to an analysis chamber 209, an analysis conveyer 223 to move the silage within the analysis chamber 209 (see FIG. 2), and a NIR scanner 113 to send energy to the silage in the analysis chamber 209 and receive reflected energy from the silage in the analysis chamber 209. The analysis chamber 209 in the illustrated embodiment is bounded by left wall 101, right wall 103, analysis conveyer 223, and a rear wall 219 (see FIG. 2). In the embodiment, the left wall 101 and the rear wall 219 are a single piece of material, with the rear wall 219 formed by a bend in the left wall 101.

The hopper 107 includes walls to constrain the silage as it enters the entrance port 109. The walls of the hopper 107 prevent the silage from moving laterally and falling outside of the hopper 107 or out of the end of the silage analysis system 100. The floor of the hopper 107 is formed by one or both of conveyor guide 205 (see FIG. 2) and the conveyer 105, so that the silage in the hopper 107 rests against the conveyor guide 205 and/or the conveyer 105. During operation, silage is removed from the hopper 107 by the conveyer 105. The hopper 107 may also include, in an embodiment, removable partitions (not shown) within the hopper 107. The partitions (not shown) may be inserted or removed from the hopper 107 to change the volume of silage that the hopper 107 may hold.

The conveyer 105 moves between a first conveyer drive 201 and a second conveyer drive 203. The conveyer 105, in an embodiment, rests on the conveyer guide 205, which supports the weight of the conveyer 105 and the silage while the conveyer 105 is in operation. A return guide 207 also supports the conveyer 201. The first conveyer drive 201 and the second conveyer drive 203, in the embodiment shown in FIGS. 1-4, each include gear wheels with sprockets to interact with projections or apertures on the conveyer 105 in order to drive the movement of the conveyer 105. In another embodiment, the first conveyer drive 201 and the second conveyer drive 203 may drive the movement of the conveyer 105 using friction. The conveyer 105, during operation and from the view shown in FIG. 2, moves in a counterclockwise direction, moving silage from the hopper 107 to the end of the conveyer 105, towards the first conveyer drive 201. The first conveyer drive 201 and/or the second conveyer drive 203 may be turned with a motor, or may be turned by a belt or other mechanical mechanism from an engine or motor positioned away from the silage analysis system 100. For example, the first conveyer drive 201 and/or the second conveyer drive 203 may extend outside of the silage analysis system 100 from the left wall 101, and may be rotated using an external engine or motor. Rotation of the first conveyer drive 201 and/or the second conveyer drive 203 drives the movement of the conveyer 105.

In the embodiment shown in FIG. 1, silage moving on the conveyer 105 is constrained on three sides by the conveyer 105 and by the left wall 101 and right wall 103. The conveyer 105, in an embodiment, includes projections 270 (one referenced in FIG. 2) on the outer surface of the conveyer to grip the silage and move the silage in the upward direction of the conveyer 105. In an embodiment, the conveyer 105 is a solid belt between projections 270. In another embodiment, the conveyer 105 is made up of interlocking or interconnected brackets so that the conveyer 105 resembles a chain and the spaces between projections 270 are generally open.

The conveyer 105 moves the silage out of the hopper 107, and along the conveyer 105 towards the top of the silage apparatus 100. When the silage reaches the end of the conveyer 105, near the first conveyer drive 201, the silage falls into the analysis chamber 209. In an embodiment, the silage is prevented from being projected out of the silage analysis system 100 by the rear wall 219. That is, the silage may be projected against the rear wall 219 by the conveyer 105, depending on the speed of the conveyer 105, but the silage strikes the rear wall 219 and falls into the analysis chamber 209.

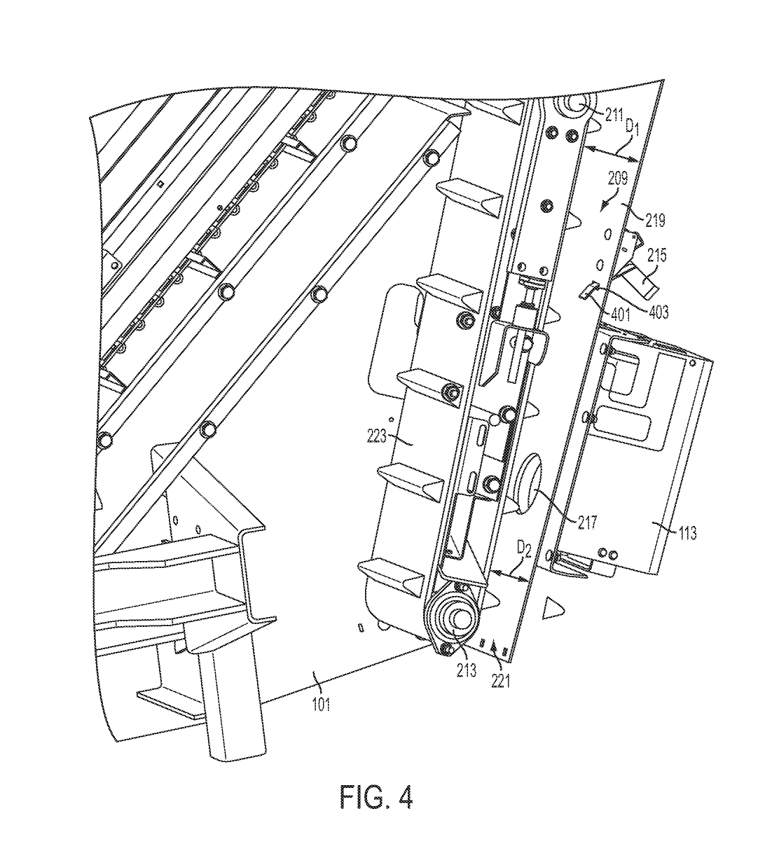

The analysis chamber 209 is bounded on four sides by the right wall 103, the left wall 101, the rear wall 219, and the analysis conveyer 223. The analysis chamber 209 has an open top end and an open bottom end. The analysis conveyer 223 is angled with respect to the rear wall 219, so that the distance between the analysis conveyer 223 and the rear wall 219 at the beginning of the analysis conveyer 223 near the conveyer 105 is greater than the distance between the analysis conveyer 223 and the rear wall 219 at the end of the analysis conveyer 223 near the exit port 221. Put another way, distance D1 in FIGS. 2 and 4 is greater than distance D2. In one embodiment, analysis conveyer 223 is angled towards rear wall 219 at about 2.5 degrees. As the analysis conveyer 223 moves silage through the analysis chamber 209, the decreasing distance compresses the silage. The compression of the silage may increase the consistency of the silage density as it moves across the NIR window 217, allowing for a more consistent analysis by the NIR scanner 113. Also, the compression of the silage may remove pockets of air from the silage, also making NIR analysis more consistent.

The analysis conveyer 223 moves between a first analysis conveyer drive 211 and a second analysis conveyer drive 213. The first analysis conveyer drive 211 and the second analysis conveyer drive 213, in the embodiment shown in FIGS. 1-4, include a gear wheel with sprockets to interact with projections or apertures on the analysis conveyer 223 and drives the movement of the analysis conveyer 223. In another embodiment, the first analysis conveyer drive 211 and the second analysis conveyer drive 213 may drive the movement of the analysis conveyer 223 using friction. The analysis conveyer 223, during operation and from the view in FIG. 2, moves in a counterclockwise direction, which forces the silage in a downward direction through the analysis chamber 209 and toward the exit port 221. The analysis conveyer 223, in an embodiment, includes projections 272 (one referenced in FIG. 2) on the outer surface of the belt to grip the silage and move the silage in the direction of movement of the analysis conveyer 223.

The first analysis conveyer drive 211 and/or the second analysis conveyer drive 213 may be turned with a motor, or may be turned by a belt or other mechanical mechanism from an engine or motor positioned away from the silage analysis system 100. For example, the first analysis conveyer drive 211 and/or the second analysis conveyer drive 213 may extend outside of the silage analysis system 100 from the left wall 101, and may be rotated using an external engine or motor. Rotation of the first analysis conveyer drive 211 and/or the second analysis conveyer drive 213 drives the movement of the analysis conveyer 223.

The NIR scanner 113 includes an energy source and one or more detectors. The energy source may be, for example and without limitation, one or more light emitting diodes or one or more light bulbs. In operation, the energy source is energized and transmits energy. The energy from the energy source strikes the target and is reflected by the target. The reflected energy radiates from the target to the detector or detectors, where wavelength and intensity of the reflected energy are measured. In an embodiment, a prism is used to separate the wavelengths of reflected energy for analysis by the one or more detectors. The wavelength and intensity data are analyzed to yield, for example, a moisture content of the target. Other physical properties of the target may also be measured, either in place of or in addition to the moisture content.

The NIR scanner 113 is positioned outside of the analysis chamber 209. A NIR window 217 allows energy to be transmitted from the NIR scanner 113 and into the analysis chamber 209, and allows reflected energy to be transmitted from the analysis chamber 209 to the one or more detectors in the NIR scanner 113. The NIR window 217 is, in an embodiment, optically transparent to some or all of the energy from the NIR scanner 113 and the reflected energy from the silage in the analysis chamber 209. The NIR window 217 is shown in FIG. 4. While a NIR scanner 113 is shown in the embodiment and described herein, it should be appreciated that any spectroscopic device may be used to project energy into the analysis chamber 209 and receive reflected energy from material in the analysis chamber 209. Additionally, other properties besides moisture content may be measured. For example, and without limitation, elemental analysis, chromatographic analysis, analysis of evolved gasses from a product in the analysis chamber 209, or other chemical analyses may be performed in place of, or along with, moisture content analysis.

Referring to FIG. 4, a switch 215 is provided which controls the activation of NIR scanner 113 so that the NIR scanner 113 does not need to be activated continuously. Switch 215 has a first state wherein the NIR scanner is not activated and a second state wherein the NIR scanner is activated. The switch 215 may be mechanical or optical, and the switch 215 activates if silage moves across the switch 215. For example, if the switch 215 is mechanical, the switch normally in the first state, but when silage is moving in the analysis chamber 209 across the switch 215 the silage actuates the switch 215 and changing its state to the second state. If the switch 215 is optical, silage moving in front of the optical switch activates the switch 215. If silage is not present in the analysis chamber 209, or if an amount of silage is not present in the analysis chamber 209 to allow for moisture content analysis, then the switch 215 does not activate. The activation of the switch 215 activates the NIR scanner 113, so that the NIR scanner 113 is in operation while silage is present in the analysis chamber 209, and the NIR scanner 113 is not in operation while silage is not present in the analysis chamber 209. A mechanical switch 215 is shown in FIG. 4. The mechanical switch 215 includes a projection 401 extending from the outer surface of the rear wall 219 to the inner surface of the rear wall 219 through an aperture 403 positioned above the NIR window 217. The projection 401 extends into the analysis chamber 209. The projection is biased to a first position. As silage flows through the analysis chamber 209, the silage presses against the projection 401 moving it from the first position and activating the switch 215 which in turn activates the NIR scanner 113 so that the NIR scanner 113 begins scanning when the silage is in front of the NIR window 217. Once the silage passes, the projection 401 returns to the first position.

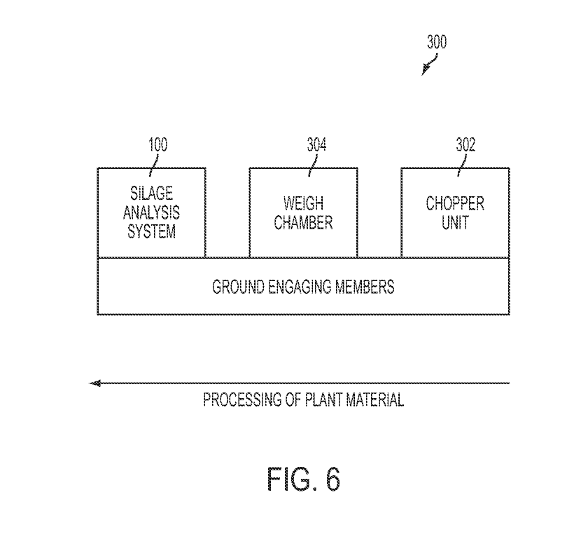

In operation, the silage analysis system 100, in an embodiment, is mounted to a silage sampler 300 (see FIG. 6). For example, and without limitation, the silage analysis system 100 may be mounted to a Hege brand silage sampler or a Haldrup brand silage sampler. Referring to FIG. 6, the silage sampler 300 inlcudes a chopper unit 302 to chop the silage and a weigh chamber 304 into which the silage is placed. Once a given sample of silage has been placed in the weigh chamber, it is weighed and transferred to the hopper 107 of the silage analysis apparatus.

Silage enters the silage analysis system 100 via the entrance port 109. If more silage enters the entrance port 109 than can be carried by the conveyer 105, the excess silage is held in the hopper 107 until it can be moved. In another embodiment, the conveyer 105 does not move until an amount of silage is present in the hopper 107, and then the conveyer 105 is operated to remove the silage from the hopper 107. The conveyer 105 may be manually activated by a user, or the conveyer 105 may be automatically activated according to the volume or weight of the silage in the hopper 107. For example, and without limitation, a weight sensor or an optical sensor (not shown) may be present in the hopper 107, so that when a predetermined weight is reached, or a predetermined volume is reached, the conveyer 105 is activated.

When the conveyer 105 is activated, and silage is present on the conveyer 105 or in the hopper 107, the silage is moved along the direction of the conveyer 105. The silage is held on the conveyer 105 by gravity and/or by the projections on the conveyer 105. The silage is constrained from substantial lateral movement while on the conveyer 105 by the left wall 101 and the right wall 103 of the silage analysis system 100. When the silage reaches the end of the conveyer 105, the silage falls into the analysis chamber 209.

In the analysis chamber 209, the silage is constrained by the left wall 101, the right wall 103, the rear wall 219, and the analysis conveyer 223 of the silage analysis system 100. The analysis conveyer 223 moves in a counterclockwise direction with respect to FIG. 2, so that the silage in the analysis chamber 209 moves in a downward direction towards the exit port 221. While in the analysis chamber 209, the projections 272 of the analysis conveyer 223 grip the silage and move it in a downward direction. The analysis conveyer 223 is angled with respect to the rear wall 219, so that the distance from the analysis conveyer 223 to the rear wall 219 at point D1 is greater than the distance from the analysis conveyer 223 to the rear wall 219 at point D2. The angle of the analysis conveyer 223 with respect to the rear wall 219 compresses the silage as the silage moves along the analysis chamber 209 towards the exit port 221.

As the silage moves within the analysis chamber 209, the silage activates the switch 215. The switch activation activates the NIR scanner 113.

As the silage moves through the analysis chamber 209, it passes in front of the NIR window 217. The NIR scanner 113 projects energy of one or more wavelengths through the NIR window 217 and onto the silage. The reflected light from the silage passes through the NIR window 217 and into the NIR scanner 113. The NIR scanner 113 contains a detector or a plurality of detectors to detect the intensity and wavelength of the reflected energy.

The information gathered from the one or more detectors is provided to a system for determination of moisture content and/or further analysis using known techniques. In an embodiment, the data is transmitted via, for example and without limitation, a network or a dedicated connection, such as a universal serial bus (“USB”) cable from the NIR scanner 113 to a computer system. In another embodiment, the data may be transmitted from the NIR scanner 113 to a computer system via a wired or wireless network. In another embodiment, the NIR scanner 113 may store the data on a removable storage unit, such as a USB drive, and the removable storage unit may be removed from the NIR scanner 113 and inserted in or connected to a computer system. The data may be associated with the specific batch in the analysis chamber 209, and the data may be stored for use or analysis. For example, and without limitation, data from different samples within the same batch may be averaged to yield an average moisture content for the entire batch of silage, or a range of moisture content readings for the batch of silage may be calculated.

The NIR scanner 113 may calculate moisture content at predetermined intervals. For example, the NIR scanner 113 may calculate the moisture content of silage present in the analysis chamber 209 at frequency intervals of, for example and without limitation, milliseconds, seconds, minutes, or any range in between. In an embodiment, the interval is determined by the user. In another embodiment, the interval is set by the silage analysis system 100, and may be static or dynamic. For example, and without limitation, the NIR scanner 113 may be set to detect moisture content every second, but if the moisture values from one sample to the next change rapidly, then the NIR scanner 113 may be reset to detect moisture content every tenth of a second.

If no more silage is present in the analysis chamber 209, or the volume of silage present in the analysis chamber 209 is not sufficient to analyze, the switch 215 deactivates, deactivating the NIR scanner 113. A small amount of silage may remain in the analysis chamber 209, for example, after an analysis sequence is complete, but the small amount may be insufficient to read the moisture content, or the batch of silage may be complete.

After the silage passes by the NIR window 217, the analysis conveyer 223 continues to force the silage through the analysis chamber 209 toward the exit port 221. The silage exits the silage analysis system 100 via the exit port 221.

After the silage is removed from the hopper 107 by the conveyer 105, silage from a second or subsequent plot may be discharged from the silage sampler 300 into the hopper 107. The hopper 107 may be loaded with silage from a subsequent plot before the silage from the first plot is fully analyzed by the NIR scanner 113 thereby permitting generally continuous operation of the silage sampler 300.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A method of collecting data to determine a moisture content of a sample of plant material, the method comprising the steps of:
providing an analysis chamber with a window and a scanner located outside of the analysis chamber;
moving the sample of plant material through the analysis chamber;
compressing the sample of plant material against the window as the sample of plant material is being moved through the analysis chamber; and
analyzing the sample of plant material with the scanner through the window to produce data.

2. The method of claim 1, wherein the scanner is a near-infrared scanner.

3. The method of claim 2, wherein the window is substantially optically transparent to near-infrared wavelengths.

4. The method of claim 1, wherein the step of moving the sample of plant material through the analysis chamber includes the steps of:
contacting the sample of plant material with an analysis conveyer; and
actuating the analysis conveyer to translate the sample of plant material through the analysis chamber.

5. The method of claim 4, wherein the step of compressing the sample of plant material against the window as the sample of plant material is being moved through the analysis chamber includes the step of reducing a separation between the analysis conveyer and a wall of the analysis chamber, the wall including the window.

6. The method of claim 1, wherein the sample of plant material is maize silage.

7. The method of claim 6, wherein the step of compressing the sample of plant material against the window as the sample of plant material is being moved through the analysis chamber removes substantially all of the air pockets between the maize silage and the window.

8. The method of claim 1, further comprising the step of determining a moisture content of the sample.

9. A method of collecting data to determine moisture content of a plurality of samples of plant material, the method comprising the steps of:
receiving a first sample of plant material in a hopper;
transporting the first sample of plant material from the hopper to an analysis chamber with a window and a scanner located outside of the analysis chamber; and
analyzing the first sample of plant material with the scanner through the window while a second sample of plant material is being one of received in the hopper and transported from the hopper to the analysis chamber.

10. The method of claim 9, further comprising the steps of:
moving the first sample of plant material through the analysis chamber; and
compressing the first sample of plant material against the window as the first sample of plant material is being moved through the analysis chamber.

11. The method of claim 9, wherein the first sample of plant material is received in the hopper from a weigh chamber of a mobile silage sampler machine.

12. An apparatus for collecting data to determine a moisture content of a sample of plant material, comprising:
an analysis chamber bounded by a plurality of walls, the analysis chamber including an entrance and an exit, a first wall having an opening therein;
a window covering the opening in the first wall;
a scanner positioned to project energy through the window into the analysis chamber onto the sample of plant material and to receive reflected energy from the sample of plant material through the window; and
an analysis conveyer to move the sample of plant material through the analysis chamber, the sample of plant material being compressed against the window as the sample of plant material is being moved through the analysis chamber.

13. The apparatus of claim 12, wherein a separation between the first wall and the analysis conveyer is reduced to compress the sample of plant material against the window.

14. The apparatus of claim 13, wherein a space between the first wall and the analysis conveyer is wedge shaped.

15. The apparatus of claim 12, wherein the scanner is a near-infrared scanner and the window is substantially optically transparent to near-infrared wavelengths.

16. The apparatus of claim 12, wherein the sample of plant material is maize silage.

18. The apparatus of claim 12, wherein the compression removes substantially all of the air pockets between the sample of plant material and the window.

19. The apparatus of claim 12, further comprising a hopper to store the sample of plant material prior to the sample of plant material being moved to the analysis chamber.

20. The apparatus of claim 19 wherein the sample of plant material is moved from the hopper to the analysis chamber on a conveyer.

21. The apparatus of claim 12, further comprising a switch positioned to monitor the analysis chamber, wherein the switch is activated when the sample of plant material is in the analysis chamber and is deactivated when the sample of plant material is absent from the analysis chamber.

22. The apparatus of claim 21, wherein the scanner is activated when the switch is activated and is deactivated when the switch is deactivated.
